(19) United States
(12) Patent Application Publication
(10) Pub. No.: US 2025/0223766 A1
(43) Pub. Date: Jul. 10, 2025

(54) METHODS OF TREATING BITUMEN-CONTAINING SURFACES

(71) Applicant: Bard Global Holdings, Inc., Lakewood, CO (US)

(72) Inventors: Stephen KLUGHERZ, Lakewood, CO (US); Bhavik PATEL, Winchester, VA (US)

(21) Appl. No.: 19/012,693

(22) Filed: Jan. 7, 2025

Related U.S. Application Data
(60) Provisional application No. 63/618,837, filed on Jan. 8, 2024.

(51) Int. Cl. E01H 1/10; C11D 1/22; C11D 1/72; C11D 1/83; C11D 3/06; C11D 3/08; C11D 3/18; C11D 3/20; C11D 3/43

(52) U.S. Cl. CPC E01H 1/103; C11D 1/83; C11D 3/06; C11D 3/08; C11D 3/185; C11D 3/2068; C11D 3/43; C11D 1/22; C11D 1/72

(57) ABSTRACT

Methods of treating bitumen-containing surfaces to improve surface friction are described. The method may include applying a non-caustic composition to the bitumen-containing surface, wherein the non-caustic composition is capable of dissolving components of the bitumen-containing surface, such as tar and oil. Following application of the non-caustic composition to the bitumen-containing surface, the method may further include steps of spraying the bitumen-containing surface with water and removing loose or loosened debris from the bitumen-containing surface. In some embodiments, water is sprayed at ultra high pressure, and in some embodiments, debris is removed through the use of cyclonic airflow.

### CROSS-REFERENCE TO RELATED APPLICATION(S)

This application claims priority under 35 U.S.C. § 119(e) to U.S. Provisional Patent Application No. 63/618,837, filed Jan. 8, 2024, the entirety of which is hereby incorporated by reference.

### BACKGROUND

Bitumen, also sometimes referred to as asphalt, is a commonly used material when building roads, highways, runways, and the like. Bitumen-containing surfaces, such as the aforementioned roads, highways, and runways, must provide a certain amount of surface friction in order to provide a safe surface for cars, trucks, tractor-trailers, airplanes, etc., to travel on. In some cases, after a bitumen-containing surface has been laid, the surface friction of the bitumen-containing surface deteriorates. For example, surface friction may deteriorate over time due to asphalt bleed. Asphalt bleed may occur when too much binding material is used during the building process, or when there is a lack of air void content in the material, which means bituminous material does not have a space within the road material to expand during hot weather.

In order to improve the surface friction of bitumen-containing surfaces that have experienced a deterioration of surface friction, previously known surface treatment methods have generally relied on spraying water on the surface, potentially at very high pressure, in order to try and remove asphalt bleed. However, this process is neither efficient nor environmentally friendly. Providing high pressure water requires very large energy input, and even then, large volumetric flow rates are required for this method to be effective, which is not environmentally friendly. The large volumes of water required to carry out this method also pose logistical issues with respect to supplying and storing water on the mobile units typically used to carrying out these methods, especially in remote locations.

Previously known alternatives to using large quantities of water sprayed at high pressure have generally relied on harsh chemical treatments. For example, solvent based cleaners such as MEK, IPA, and thinners, each of which is a petroleum-based product, have been applied to bitumen-containing surfaces to try and remove asphalt bleed. These harsh chemical treatments are environmentally unfriendly, as they contain significant VOCs, negatively impact vegetation, and have harmful health effects. Due to the negative environmental impact of these chemical treatments, their use may be restricted or altogether banned by local, state, and federal agencies.

In view of the above, a need continues to exist for improved methods of improving the surface friction of bitumen-containing surfaces, with such improved methods focusing on improved energy efficiency and lower environmental impacts.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a method of treating a bitumen-containing surface includes the steps of applying to the bitumen-containing surface a non-caustic composition, spraying the bitumen-containing surface with water, and removing from the bitumen-containing surface debris resulting from applying to the bitumen-containing surface the non-caustic composition and/or spraying the bitumen-containing surface with water. The non-caustic composition may include water and propylene glycol n-propyl ether.

In some embodiments, a method of treating a bitumen-containing surface incudes the steps of applying to the bitumen-containing surface a non-caustic composition, and allowing the applied non-caustic composition to reside on the bitumen-containing surface for a time period of from about 5 to about 10 minutes before carrying out any further washing and/or debris removal steps. The non-caustic composition may include water and propylene glycol n-propyl ether.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a flow chart illustrating a method for treating bitumen-containing surfaces according to various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

Described herein are embodiments of a method for treating a bitumen-containing surface in order to improve the surface friction of the bitumen-containing surface in an efficient and environmentally friendly manner. Embodiments of the method described herein can help to ensure compliance with, e.g., federal highway administration friction standards and address safety challenges posed by excess bituminous material on roads, highways, runways, etc. Embodiments of the method described herein may be an improvement over previously known road surface treatment methods by significantly reducing wastewater production and fuel consumption.

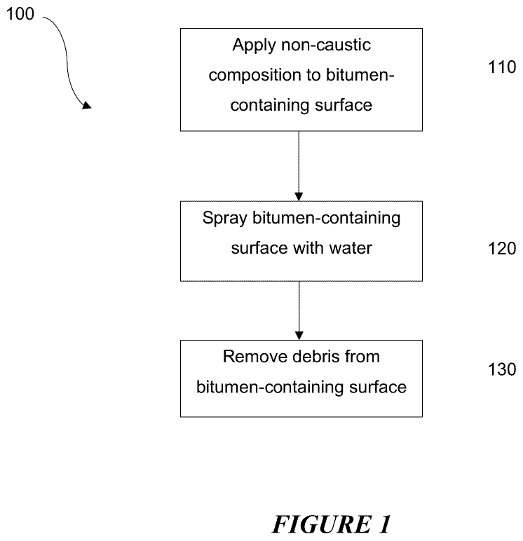

With reference to FIG. 1, a method 100 of treating a bitumen-containing surface generally includes a step 110 of applying to the bitumen-containing surface a non-caustic composition, a step 120 of spraying the bitumen-containing surface with water, and a step 130 of removing from the bitumen-containing surface debris resulting from applying to the bitumen-containing surface the non-caustic composition and/or spraying the bitumen-containing surface with water.

In step 110, a non-caustic composition is applied to a bitumen-containing surface. The non-caustic composition generally includes water and propylene glycol n-propyl ether. In some embodiments, the non-caustic composition is from about 65 to about 80 wt. % water and from about 5 to 10 wt. % propylene glycol n-propyl ether. In one specific, though non-limiting, example, the non-caustic composition comprises about 80 wt. % water and about 10 wt. % propylene glycol n-propyl ether.

In some embodiments, the non-caustic composition may further include one or more additives. In one non-limiting example, the non-caustic composition further includes as an additive one or more surfactants. When surfactants are present in the non-caustic composition, the composition may include at least 10 wt. % surfactant. The specific surfactant or combination of surfactant used is generally not limited. In some embodiments, the composition includes one or more of trisodium phosphate, sodium metasilicate, sodium xylene sulfonate, t-octylphenoxypolyethoxyethanol, and d-limonene. In some embodiments, the composition includes all of trisodium phosphate, sodium metasilicate, sodium xylene sulfonate, t-octylphenoxypolyethoxyethanol, and d-limonene.

The non-caustic composition may be considered non-caustic by virtue of having a pH that is less than 12.5. When the pH of the composition is greater than 12.5, the composition may be considered hazardous. In some embodiments, the pH of the non-caustic composition is about 12.

The bitumen-containing surface to which the non-caustic composition is applied is typically any bitumen-containing surface in need of treatment to, e.g., improve the surface friction of the surface. Exemplary, though non-limiting, bitumen-containing surfaces include roads, highways, and runways. In these and other surfaces, bitumen is used as a main component of the surface material when being laid. Bitumen-containing surfaces may require treatment to improve surface friction when asphalt bleed occurs. Asphalt bleed may occur when too much binding material is used when laying the road, highway, runway, etc., and/or through lack of air void content in the asphalt composition into which bitumen can expand during hot weather.

Any manner of applying the non-caustic composition to the bitumen-containing surface can be used provided that the non-caustic composition is suitably distributed on the bitumen-containing surface in sufficient quantities. In some embodiments, the non-caustic composition is applied by spraying the non-caustic composition on the bitumen-containing surface. The pressure at which the non-caustic composition is applied is generally not an important factor to the methods described herein. Instead, the application of non-caustic composition to the bitumen-containing surface should focus on sufficiently saturating the bitumen-containing surface. In some embodiments, sufficient saturation can be accomplished by applying one gallon of non-caustic composition per 180 sqft of bitumen-containing surface. Even distribution of the non-caustic composition is preferred.

Once applied, embodiments of the method described herein may call for the non-caustic composition to reside on the bitumen-containing surface for a period of time before any further processing steps are carried out. By allowing the non-caustic composition to reside on the bitumen-containing surface for a period of time, this ensures that the non-caustic composition can interact with the bitumen-containing surface to achieve the desired result, namely, the softening and dilution of oil and tar components of the bitumen-containing surface. More specifically, the non-caustic composition is capable of solubilizing tars and oils when allowed to dwell on the bitumen-containing surface for a set period of time. In some embodiments, the dwell time for the non-caustic composition is in the range of from about 5 to about 10 minutes.

Following application of the non-caustic composition to the bitumen-containing surface and, in some embodiments, allowing the non-caustic composition to reside on the bitumen-containing surface for a period of time, step 120 generally includes spraying the bitumen-containing surface with water. Spraying the bitumen-containing surface with water can serve to loosen and separate components of the bitumen-containing surface, including components of the bitumen-containing surface that have been altered by the preceding step of applying the non-caustic composition to the bitumen-containing surface. For example, where the non-caustic composition has softened and diluted components of the bitumen-containing surface, the step of spraying the bitumen-containing surface with water can serve to further loosen and/or separate these components from the bitumen-containing surface.

In order to effectively loosen and/or separate components of the bitumen-containing surface, various aspects of how the water is sprayed at the bitumen-containing surface can be adjusted. For example, the pressure at which the water is sprayed can be adjusted. In some embodiments, the water is sprayed at ultra high pressure, i.e., at pressure of 25,000 psi or greater. However, step 120 can also be carried out using a pressure less than ultra high pressure. However, when ultra high pressure is used, this may reduce the amount of water needed to effectively loosen and separate debris from the bitumen-containing surface. In some embodiments, when ultra high pressure is used, the water is sprayed at a rate of about 6 gallons per minute. When pressure below ultra high pressure is used, this may require greater amounts of water (e.g., greater than 6 gallons per minute) in order to achieve satisfactory loosening and separation of debris. In some embodiments, ultra high pressure is used at least in part because of the economical and environmental benefits of requiring less water to separate and loosen debris.

The rate of travel when carrying out step 120 is generally not limited. In some embodiments, the rate of travel for step 120 is in the range of about 25 to about 150 feet per minute. When ultra high pressure is used, the rate of travel may be faster than when non-ultra high pressure is used, while still achieving the desired loosening and separating of debris from the bitumen-containing surface.

In some embodiments, the spray nozzles used to spray water at the bitumen-containing surface are aligned in a direction generally perpendicular to the bitumen-containing surface. However, other alignments can be used, including instances where the alignment of the spray nozzle is variable during application.

In step 130, loose or loosened debris resulting from steps 110 and 120 is removed from the bitumen-containing surface. Removing the loose or loosened debris ensures that any components of the bitumen-containing surface that have been dissolved, diluted, and or loosened by the preceding steps are not left behind on the bitumen-containing surface where, over time, they could be re-integrated into the bitumen-containing surface and negate the improvement in surface friction resulting from their removal. Any manner of removing debris from the bitumen-containing surface can be used, such as via vacuum or suction. However, in some embodiments, step 130 preferably employs cyclonic airflow to pull debris up and away from the bitumen-containing surface.

In embodiments where cyclonic airflow is used, cyclonic airflow may be produced through the use of rotating curved blades. A benefit of using cyclonic airflow such as those created by rotating curved blades is that the upward force created by the rotating curved blades is evenly distributed across the surface, as opposed to, e.g., traditional vacuum systems that exhibit localized suction near the suction port, but low vacuum forces away from the port.

In some embodiments, steps 120 and 130 are performed simultaneously or near-simultaneously. For example, a system can be used where the cleaning head includes jets for spraying water at the bitumen-containing surface slightly in front of, slightly behind, and/or generally in the same location as rotating curved blades that create upward cyclonic airflow. Carrying out steps 120 and 130 simultaneously or near simultaneously may provide advantages due to the way in which the sprayed water and cyclonic airflow work in concert. For example, when the cyclonic airflow is pulling debris away from the bitumen-containing surface immediately in the vicinity of where water is being sprayed, this helps to ensure the sprayed water is unimpeded as it contacts the bitumen-containing surface, which thereby improves the ability of the sprayed water to interact with further loose or loosened debris. Examples of systems capable of employing ultra high pressure water and cyclonic airflow at the same time include cleaning heads manufactured by Cyclone Technology of Tempe, AZ.

Regardless of the manner in which debris is removed from the bitumen-containing surface, step 130 may further include collecting the removed debris. For example, in the case of vacuum power being used to remove debris from the surface, a sealed vacuum tank be used to collect and store removed debris. In the case of cyclonic airflow, the system may pump removed debris using positive pressure to an open-to-the-atmosphere recovery bin.

Embodiments of the method described herein may provide numerous benefits as compared to previously known methods for treating bitumen-containing surfaces. These benefits may include some or all of the following:

Efficiency: The combination of the non-caustic composition and ultra-high-pressure water blasting is a more efficient manner of removing excess bituminous material from surfaces and improving surface friction. This efficiency reduces the need for time-consuming manual labor or multiple passes, enhancing productivity.

Cost: The combination of reduced water usage and minimized fuel consumption compared to previously known methods translates into cost savings for the user. The technology described herein requires less water and energy, making it a cost-effective solution for surface treatment and debris recovery.

Environmental Sustainability: The method described herein has a reduced environmental impact by using a low water flow ultra-high-pressure water blasting and a non-caustic composition that may be considered environmentally friendly. The process minimizes water wastage and avoids the use of harsh chemicals. This eco-friendly approach contributes to environmental sustainability and aligns with modern environmental regulations and practices.

Compliance with Standards: The process described herein ensures compliance with federal highway administration friction standards, which is crucial for road safety. It not only removes excess bituminous material but also improves surface friction, reducing the risk of accidents and enhancing road safety.

Versatility: The process described herein is adaptable to various applications, including road and runway maintenance, and any scenario requiring effective surface treatment and debris recovery. Its versatility makes it a valuable tool in multiple industries and settings.

Reduced Wastewater Production: Traditional surface treatment methods often generate significant amounts of wastewater, which can pose disposal challenges and environmental concerns. The reduced water usage in the process described herein leads to significantly lower wastewater production, reducing the environmental impact and simplifying wastewater management.

Improved Surface Friction: Beyond compliance with standards, the process described herein leads to improved surface friction. This benefit is particularly important in transportation settings, where maintaining adequate friction can prevent accidents and improve overall road and runway safety.

Safety: The use of the non-caustic composition described herein enhances safety for both operators and the environment.

Long-Term Durability: By effectively removing excess bituminous material and contaminants from surfaces, the process described herein can contribute to long-term durability, reducing the need for frequent roadway maintenance.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/we claim:

1. A method of treating a bitumen-containing surface, comprising:
applying to the bitumen-containing surface a non-caustic composition, wherein the non-caustic composition comprises water and propylene glycol n-propyl ether;
spraying the bitumen-containing surface with water; and
removing from the bitumen-containing surface debris resulting from applying to the bitumen-containing surface the non-caustic composition and/or spraying the bitumen-containing surface with water.

2. The method of claim 1, wherein the non-caustic composition comprises about 80 wt. % water and about 10 wt. % propylene glycol n-propyl ether.

3. The method of claim 1, wherein the non-caustic composition has a pH of about 12.

4. The method of claim 1, wherein the non-caustic composition further comprises one or more surfactants.

5. The method of claim 4, wherein the one or more surfactants are present in the non-caustic composition in an amount of at least about 10 wt. %.

6. The method of claim 1, wherein applying to the bitumen-containing surface a non-caustic composition comprises applying the non-caustic composition at a rate of about one gallon of non-caustic composition per 180 sqft of bitumen-containing surface.

7. The method of claim 1, further comprising:
prior to spraying the bitumen-containing surface with water, allowing the applied non-caustic composition to reside on the bitumen-containing surface for a period of time sufficient for the non-caustic composition to solubilize at least some bituminous material present in the bitumen-containing surface.

8. The method of claim 1, further comprising:
prior to spraying the bitumen-containing surface with water, allowing the applied non-caustic composition to reside on the bitumen-containing surface for a time period of from about 5 to about 10 minutes.

9. The method of claim 1, wherein spraying the bitumen-containing surface with water comprises spraying the bitumen-containing surface with water at an ultra high pressure.

10. The method of claim 9, wherein the ultra high pressure is a pressure of 25,000 psi or greater.

11. The method of claim 9, wherein the flow rate of spraying the bitumen-containing surface with water at ultra high pressure is about 6 gallons of water per minute.

12. The method of claim 9, wherein spraying the bitumen-containing surface with water at ultra-high pressure is performed at a rate of from about 25 to about 150 feet per minute.

13. The method of claim 1, wherein removing from the bitumen-containing surface debris comprises employing cyclonic airflow.

14. The method of claim 1, wherein spraying the bitumen-containing surface with water and removing from the bitumen-containing surface debris are performed simultaneously or near simultaneously.

15. A method of treating a bitumen-containing surface, comprising:
applying to the bitumen-containing surface a non-caustic composition, wherein the non-caustic composition comprises water and propylene glycol n-propyl ether; and
allowing the applied non-caustic composition to reside on the bitumen-containing surface for a time period of from about 5 to about 10 minutes before carrying out any further washing and/or debris removal steps.

16. The method of claim 15, wherein the non-caustic composition comprises about 80 wt. % water and about 10 wt. % propylene glycol n-propyl ether.

17. The method of claim 16, wherein the non-caustic composition has a pH of about 12.

18. The method of claim 16, wherein the non-caustic composition further comprises one or more surfactants, wherein the one or more surfactants are selected from the group consisting of trisodium phosphate, sodium metasilicate, sodium xylene sulfonate, t-octylphenoxypolyethoxyethanol, and d-limonene.

19. The method of claim 18, wherein the one or more surfactants are present in the non-caustic composition in an amount of at least about 10 wt. %.

20. The method of claim 18, wherein the non-caustic composition comprises at least five surfactants, the at least five surfactants being trisodium phosphate, sodium metasilicate, sodium xylene sulfonate, t-octylphenoxypolyethoxyethanol, and d-limonene.
